(19) United States
(12) Patent Application Publication
(10) Pub. No.: US 2018/0162290 A1
(43) Pub. Date: Jun. 14, 2018

(54) Hands-On Wheel, Transparent Multi-Pocket Pouch for Displaying Personal Identification Documents

(71) Applicant: Paula Beth Dupas Guillory, DeRidder, LA (US)

(72) Inventor: Paula Beth Dupas Guillory, DeRidder, LA (US)

(21) Appl. No.: 15/839,792

(22) Filed: Dec. 12, 2017

Related U.S. Application Data
(60) Provisional application No. 62/433,022, filed on Dec. 12, 2016.

(51) Int. Cl. B60R 11/02; A41D 27/20

(52) U.S. Cl. CPC B60R 11/02; B60R 2011/001; A41D 27/20

(57) ABSTRACT

A hands-on wheel, transparent multi-pocket pouch for displaying personal identification documents uses a multi-pocket pouch, a transparent exterior pocket and an external device fastener to mount a user's identification documents on the steering wheel of a vehicle. The multi-pocket pouch is a transparent enclosure that has an interior pocket. The transparent exterior pocket is connected to a front face of the multi-pocket pouch so that the user is able to place a driver's license above the identification documents stored within the multi-pocket pouch. The external device fastener is connected to a rear face of the multi-pocket pouch so that the multi-pocket pouch can be attached to the vehicle's steering wheel. The present invention can be made of flexible materials capable of conforming to the shape of the steering wheel.

The current application claims a priority to the U.S. Provisional Patent application Ser. No. 62/433,022 filed on Dec. 12, 2016.

### FIELD OF THE INVENTION

The present invention relates generally to an identification holder. More specifically, the present invention relates to a transparent enclosure that can be attached to the steering wheel of a vehicle.

### BACKGROUND OF THE INVENTION

The present invention is a layperson's attempt at reducing the excessive use of force in custodial environments, especially in connection with traffic stops. In recent months, news media outlets have been flooded with reports of fatalities and/or serious bodily injuries sustained by citizens from what to the innocent bystander seemed to be an ordinary traffic stop. Misconstruing the otherwise innocent body movements of a person occupying the stopped vehicle can unintentionally generate an escalation in the use of force by the law enforcement agent conducting the traffic stop. In response, the present invention advocates that if a person is involved in a traffic stop, eliminating unnecessary body movements can be accomplished by the placement of a see-through pouch on the steering wheel.

### BRIEF DESCRIPTION OF THE DRAWINGS

FIG. 1 is an exploded view perspective view of the present invention.

FIG. 2 is an exploded view perspective view of the present invention showing the at least one interior pocket.

FIG. 3 is a rear view of the present invention.

FIG. 4 is a top view of the first alternative embodiment of the present invention, in this view the at least one interior pocket is a plurality of interior pockets.

FIG. 5 is a rear view of the cover used in the present invention.

FIG. 6 is a front view of the present invention attached to a steering wheel.

FIG. 7 is a front view showing multiple embodiments of the present invention attached to a steering wheel.

### DETAIL DESCRIPTIONS OF THE INVENTION

All illustrations of the drawings are for the purpose of describing selected versions of the present invention and are not intended to limit the scope of the present invention.

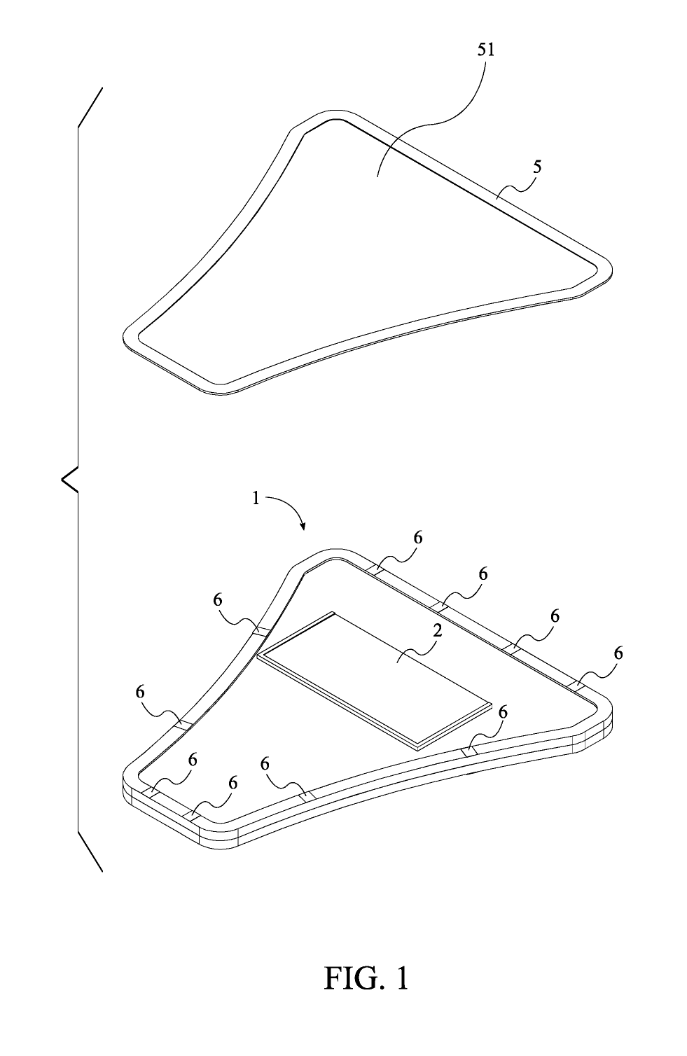

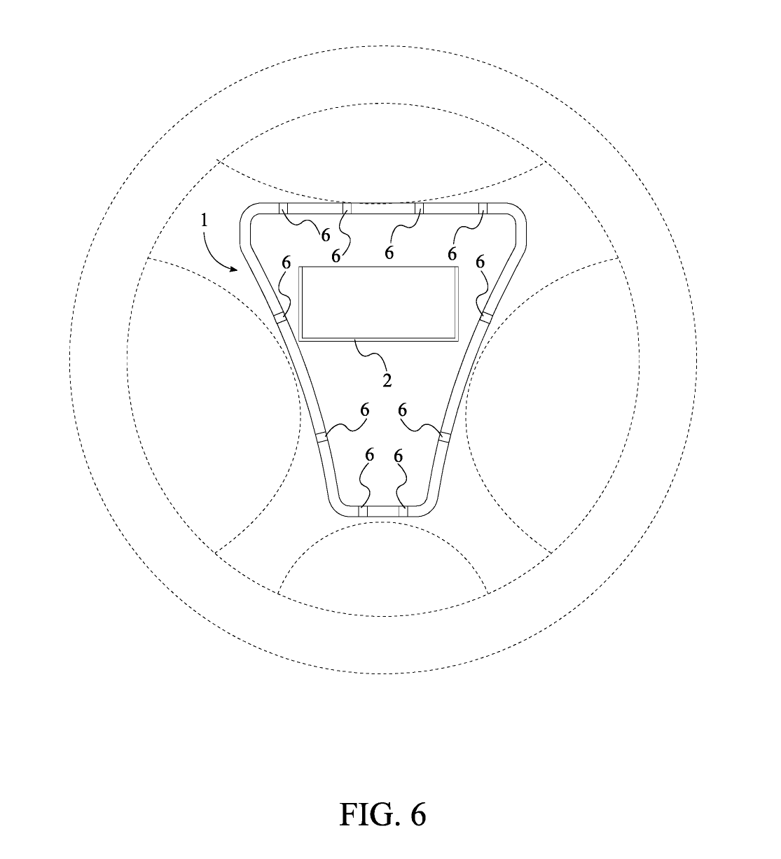

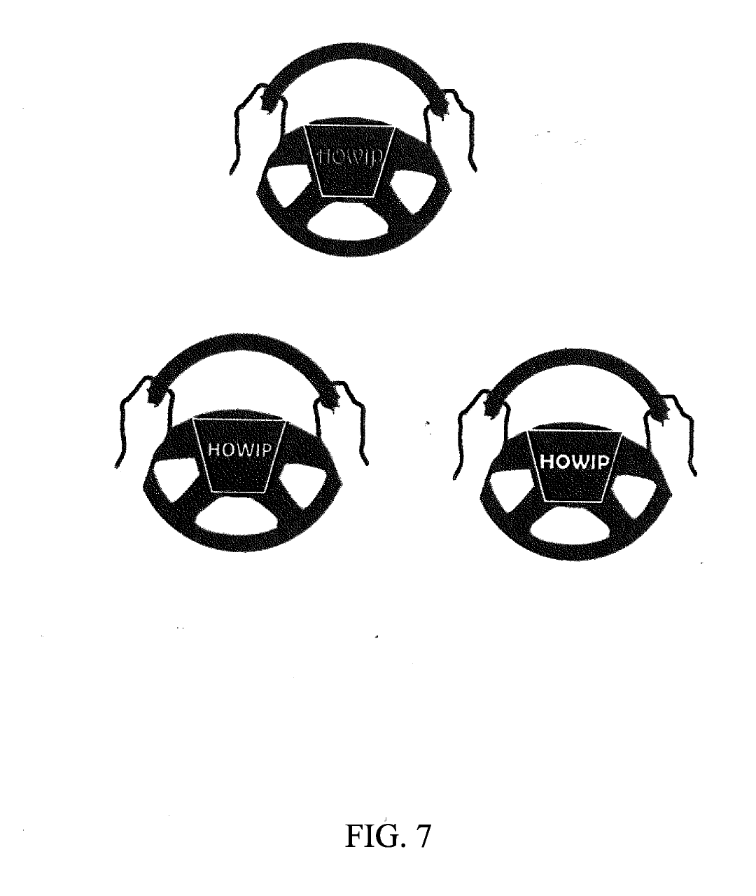

As can be seen in FIG. 1 through FIG. 7, the preferred embodiment of the present invention, the hands-on wheel, transparent multi-pocket pouch for displaying personal identification documents, is a device that can be attached to the steering wheel of a vehicle. The present invention acts as a display for a user's identification documents. The term “identification documents” is used herein to refer to a group of documents comprising driver's licenses, vehicle registration, insurance information, and emergency contacts. The present invention is designed to facilitate visual inspection of the user's identification documents without necessitating the user's hands be removed from the steering wheel of a vehicle being driven.

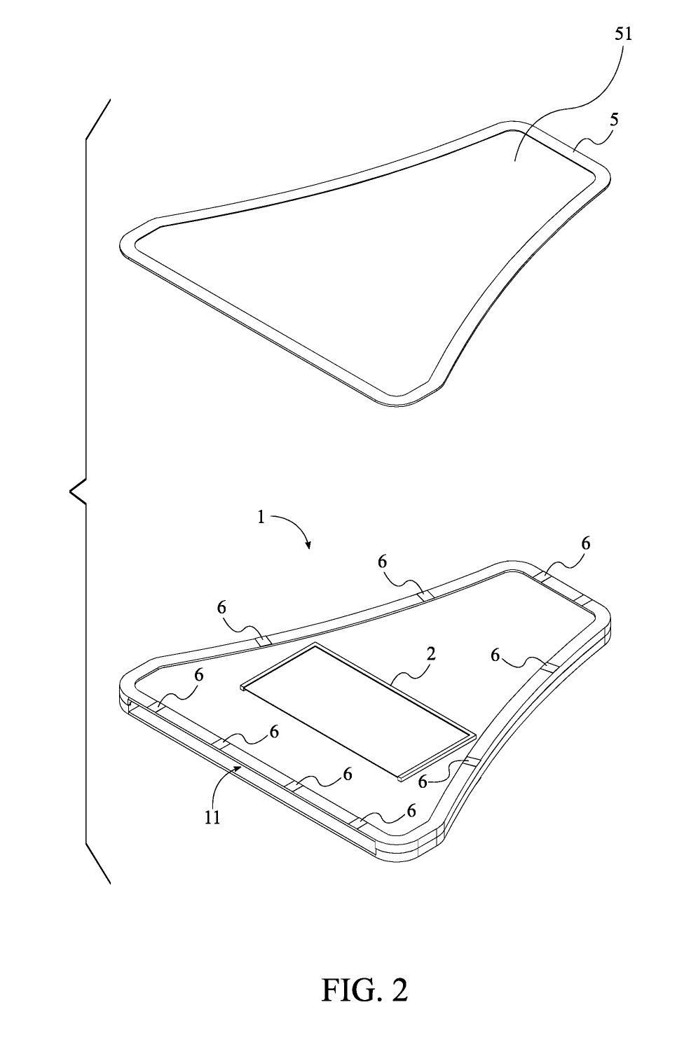

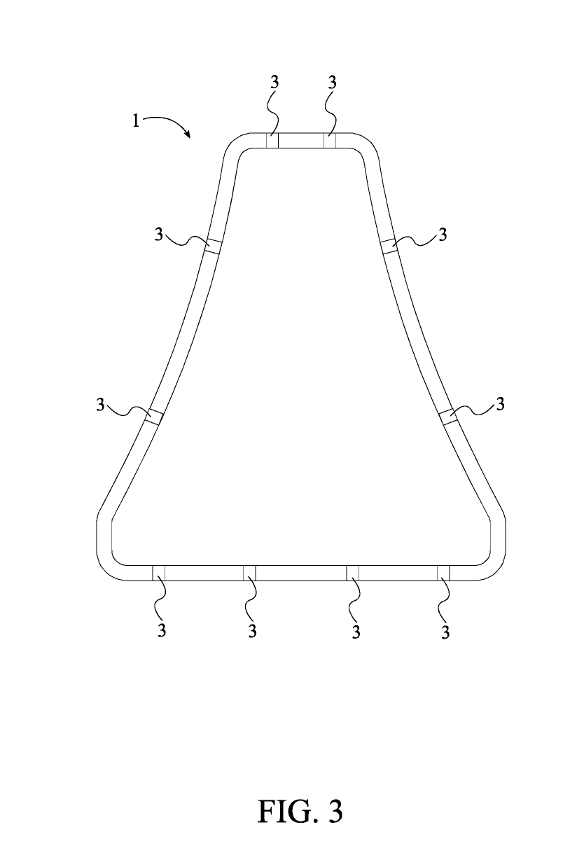

As can be seen in FIG. 1, FIG. 2, and FIG. 3, to achieve the above-described functionalities, the present invention comprises a multi-pocket pouch 1, a transparent exterior pocket 2, and an external device fastener 3. The multi-pocket pouch 1 is preferably constructed from transparent materials and functions as a storage receptacle for identification documents. To accomplish this, the multi-pocket pouch 1 comprises at least one interior pocket 11. Further, the interior pocket 11 is integrated into an interior cavity of the multi-pocket pouch 1. As a result, the interior pocket 11 acts as a receptacle for organizing and storing identification documents. The transparent exterior pocket 2 is a pocket for holding an identification card. Additionally, the transparent exterior pocket 2 is adjacently connected to a front face of the multi-pocket pouch 1. Thus positioned, the transparent exterior pocket 2 retains the identification card in a position that facilitates visual inspection. The external device fastener 3 is a fastening mechanism, which can be, but is not limited to being, a hook and loop fastener, an interconnecting clasp, an adhesive, or a magnetic coupler. Additionally, the external device fastener 3 is adjacently connected to a rear face of the multipoint pouch, opposite to the transparent exterior pocket 2. Consequently, the external device fastener 3 enables the rear face of the multi-pocket pouch 1 to be pressed against the steering wheel while the front face of the multi-pocket pouch 1 is maintained in a position that facilitates visual inspection.

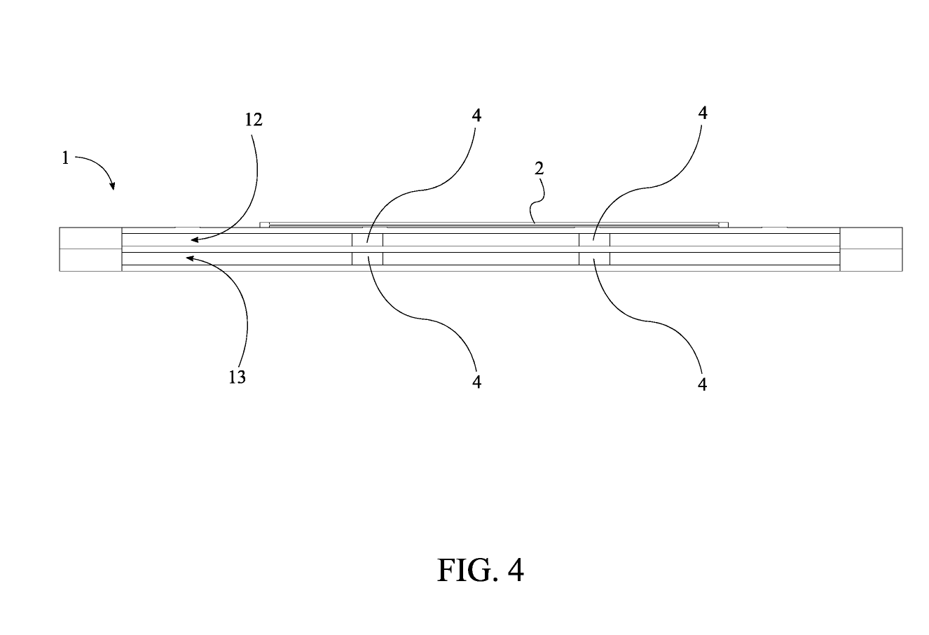

As can be seen in FIG. 1, through FIG. 4, the present invention is designed to securely store the user's identification documents while the user is driving. To facilitate this, the present invention comprises at least one pocket-closing fastener 4. Specifically, the pocket-closing fastener 4 is connected about an opening of the interior pocket 11. Accordingly, the pocket-closing fastener 4 is able to selectively seal the opening of the interior pocket 11, Thus, controlling the access to the identification documents stored within the interior pocket 11. In a first alternative embodiment, the at least one interior pocket 11 is a plurality of interior pockets 11. Furthermore, the plurality of interior pockets 11 comprises an arbitrary pocket 12 and an adjacent pocket 13. The plurality of pockets partitions the interior cavity of the multi-pocket pouch 1 to facilitate organizing the identification documents stored therein. The plurality of interior pockets 11 is preferably constructed from a series of layers, where a single interior pocket 11 is integrated into each later. As such, the arbitrary pocket 12 is positioned in between the front face of the multi-pocket pouch 1 and the adjacent pocket 13. Additionally, the adjacent pocket 13 is positioned in between the rear face of the multi-pocket pouch 1 and the arbitrary pocket 12. Accordingly, the plurality of interior pockets 11 is arranged to enable the user to position the most important identification documents directly behind the transparent front face of the multi-pocket pouch 1.

As can be seen in FIG. 1 and FIG. 2, while it is helpful to have the user's identification documents in plain view while driving, security concerns when displaying the user's personal information while the vehicle is unattended. To address these concerns, the present invention comprises an opaque cover 5. The opaque cover 5 is a panel of material designed to conform to the shape of the multi-pocket pouch 1. Additionally, the opaque cover 5 is attached across the front face of the multi-pocket pouch 1. As a result, the opaque cover 5 is able to obscure the identification documents stored within the multi-pocket pouch 1. In an alternative embodiment of the opaque cover 5, a secondary pocket is attached to the opaque cover 5. The secondary pocket is preferably a large pocket that is positioned on an interior face of the opaque cover 5. Specifically, the secondary pocket is positioned between the opaque cover 5 and the transparent exterior pocket 2 when the opaque cover 5 is attached to the multi-pocket pouch 1. This enables the user to store various personal items within the cover. The secondary pocket may comprise a secondary fastener that is used to seal the secondary pocket. Additionally, the multi-pocket pouch 1, the transparent exterior pocket 2, and the opaque cover 5 are preferably made from flexible materials.

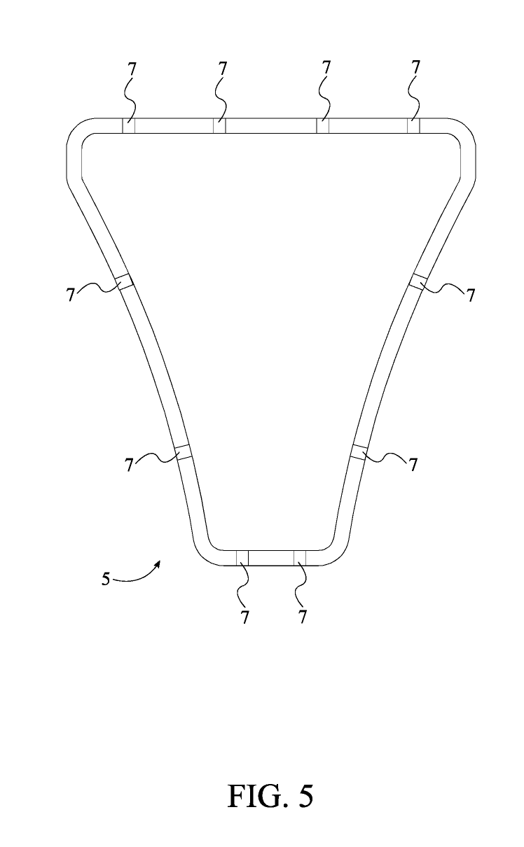

As can be seen in FIG. 1 and FIG. 5, the cover is designed to be readily attached and detached from the front face of the multi-pocket pouch 1. To facilitate this, the present invention comprises a first plurality of cover fasteners 6 and a second plurality of cover fasteners 7. The first plurality of cover fasteners 6 is adjacently connected to the front face of the multi-pocket pouch 1. Additionally, the first plurality of cover fasteners 6 is perimetrically distributed around the front face of the multi-pocket pouch 1. Thus positioned, the first plurality of cover fasteners 6 ensures the opaque cover 5 will obscure the identification documents when the opaque cover 5 is attached to the first face of the multi-pocket pouch 1. Similarly, the second plurality of cover fasteners 7 is adjacently connected to the opaque cover 5. Likewise, the second plurality of cover fasteners 7 is perimetrically distributed around the opaque cover 5. As a result, the opaque cover 5 can be attached to the first face of the multi-pocket pouch 1. Specifically, each of the first plurality of cover fasteners 6 is attached to a corresponding fastener from the second plurality of cover fasteners 7. Consequently, the opaque cover 5 can be securely attached to the front face of the multi-pocket pouch 1. The first plurality of cover fasteners 6 and the second plurality of cover fasteners 7 are preferably the respective sides of a two-component fastening mechanism. For example, a hook and loop fastener, or magnetic dipole couplers, or interlocking clasps. Relatedly, the present invention comprises a design panel 51. The design panel 51 is a panel used to provide aesthetic appeal to the present invention. As such, the design panel 51 is superimposed onto a second face of the opaque cover 5, opposite to the front face of the multi-pocket pouch 1. Thus positioned, the design panel 51 provides an aesthetic benefit to the user while the opaque cover 5 is attached to the multi-pocket pouch 1.

As can be seen in FIG. 1 and FIG. 3, the external device fastener is designed to securely attach the multi-pocket pouch 1 onto the surface of a steering wheel. To facilitate this, the external device fastener 3 is preferably a plurality of detachable fasteners 3. This plurality of detachable fasteners 3 is adjacently connected to the rear face of the multi-pocket pouch 1. Additionally, the plurality of detachable fasteners 3 is perimetrically distributed around the rear face of the multi-pocket pouch 1. As a result, the plurality of detachable fasteners 3 ensures that the multi-pocket pouch 1 conforms to the shape of the steering wheel.

Although the invention has been explained in relation to its preferred embodiment, it is to be understood that many other possible modifications and variations can be made without departing from the spirit and scope of the invention as hereinafter claimed.

What is claimed is:

1. A hands-on wheel, transparent multi-pocket pouch for displaying personal identification documents comprises:
a multi-pocket pouch;
a transparent exterior pocket;
an external device fastener;
the multi-pocket pouch comprises at least one interior pocket;
the interior pocket being integrated into an interior cavity of the multi-pocket pouch;
the transparent exterior pocket being adjacently connected to a front face of the multi-pocket pouch; and
the external device fastener being adjacently connected to a rear face of the multipoint pouch, opposite to the transparent exterior pocket.

2. The hands-on wheel, transparent multi-pocket pouch for displaying personal identification documents as claimed in claim 1 comprises:
at least one pocket-closing fastener; and
the pocket-closing fastener being connected about an opening of the interior pocket.

3. The hands-on wheel, transparent multi-pocket pouch for displaying personal identification documents as claimed in claim 1 comprises:
The at least one interior pocket being a plurality of interior pockets;
the plurality of interior pockets comprises an arbitrary pocket and an adjacent pocket;
the arbitrary pocket being positioned in between the front face of the multi-pocket pouch and the adjacent pocket; and
the adjacent pocket being positioned in between the rear face of the multi-pocket pouch and the arbitrary pocket.

4. The hands-on wheel, transparent multi-pocket pouch for displaying personal identification documents as claimed in claim 1 comprises:
an opaque cover; and
the opaque cover being attached across the front face of the multi-pocket pouch.

5. The hands-on wheel, transparent multi-pocket pouch for displaying personal identification documents as claimed in claim 4 comprises:
a first plurality of cover fasteners;
a second plurality of cover fasteners
the first plurality of cover fasteners being adjacently connected to the front face of the multi-pocket pouch;
the first plurality of cover fasteners being perimetrically distributed around the front face of the multi-pocket pouch;
the second plurality of cover fasteners being adjacently connected to a first face of the opaque cover;
the second plurality of cover fasteners being perimetrically distributed around the first face of the opaque cover; and
each of the first plurality of cover fasteners being attached to a corresponding fastener from the second plurality of cover fasteners.

6. The hands-on wheel, transparent multi-pocket pouch for displaying personal identification documents as claimed in claim 4 comprises:
a design panel; and
the design panel being superimposed onto a second face of the opaque cover, opposite to the front face of the multi-pocket pouch.

7. The hands-on wheel, transparent multi-pocket pouch for displaying personal identification documents as claimed in claim 1, wherein the multi-pocket pouch is made from a transparent material.

8. The hands-on wheel, transparent multi-pocket pouch for displaying personal identification documents as claimed in claim 1 comprises:
the external device fastener being a plurality of detachable fasteners;
the plurality of detachable fasteners being adjacently connected to the rear face of the multi-pocket pouch; and
the plurality of detachable fasteners being perimetrically distributed around the rear face of the multi-pocket pouch.

9. A hands-on wheel, transparent multi-pocket pouch for displaying personal identification documents comprises:
a multi-pocket pouch;
a transparent exterior pocket;
an external device fastener;
at least one pocket-closing fastener;
the multi-pocket pouch comprises at least one interior pocket;
the interior pocket being integrated into an interior cavity of the multi-pocket pouch;
the transparent exterior pocket being adjacently connected to a front face of the multi-pocket pouch;
the external device fastener being adjacently connected to a rear face of the multipoint pouch, opposite to the transparent exterior pocket; and
the pocket-closing fastener being connected about an opening of the interior pocket.

10. The hands-on wheel, transparent multi-pocket pouch for displaying personal identification documents as claimed in claim 9 comprises:
the at least one interior pocket being a plurality of interior pockets;
the plurality of interior pockets comprises an arbitrary pocket and an adjacent pocket;
the arbitrary pocket being positioned in between the front face of the multi-pocket pouch and the adjacent pocket; and
the adjacent pocket being positioned in between the rear face of the multi-pocket pouch and the arbitrary pocket.

11. The hands-on wheel, transparent multi-pocket pouch for displaying personal identification documents as claimed in claim 9 comprises:
an opaque cover; and
the opaque cover being attached across the front face of the multi-pocket pouch.

12. The hands-on wheel, transparent multi-pocket pouch for displaying personal identification documents as claimed in claim 11 comprises:
a first plurality of cover fasteners;
a second plurality of cover fasteners
the first plurality of cover fasteners being adjacently connected to the front face of the multi-pocket pouch;
the first plurality of cover fasteners being perimetrically distributed around the front face of the multi-pocket pouch;
the second plurality of cover fasteners being adjacently connected to a first face of the opaque cover;
the second plurality of cover fasteners being perimetrically distributed around the first face of the opaque cover; and
each of the first plurality of cover fasteners being attached to a corresponding fastener from the second plurality of cover fasteners.

13. The hands-on wheel, transparent multi-pocket pouch for displaying personal identification documents as claimed in claim 11 comprises:
a design panel; and
the design panel being superimposed onto a second face of the opaque cover, opposite to the front face of the multi-pocket pouch.

14. The hands-on wheel, transparent multi-pocket pouch for displaying personal identification documents as claimed in claim 1, wherein the multi-pocket pouch is made from a transparent material.

15. The hands-on wheel, transparent multi-pocket pouch for displaying personal identification documents as claimed in claim 1 comprises:
the external device fastener being a plurality of detachable fasteners;
the plurality of detachable fasteners being adjacently connected to the rear face of the multi-pocket pouch; and
the plurality of detachable fasteners being perimetrically distributed around the rear face of the multi-pocket pouch.

16. A hands-on wheel, transparent multi-pocket pouch for displaying personal identification documents comprises:
a multi-pocket pouch;
a transparent exterior pocket;
an external device fastener;
at least one pocket-closing fastener;
an opaque cover;
the multi-pocket pouch comprises at least one interior pocket;
the interior pocket being integrated into an interior cavity of the multi-pocket pouch;
the transparent exterior pocket being adjacently connected to a front face of the multi-pocket pouch;
the external device fastener being adjacently connected to a rear face of the multipoint pouch, opposite to the transparent exterior pocket;
the pocket-closing fastener being connected about an opening of the interior pocket; and
the opaque cover being attached across the front face of the multi-pocket pouch.

17. The hands-on wheel, transparent multi-pocket pouch for displaying personal identification documents as claimed in claim 16 comprises:
The at least one interior pocket being a plurality of interior pockets;
the plurality of interior pockets comprises an arbitrary pocket and an adjacent pocket;
the arbitrary pocket being positioned in between the front face of the multi-pocket pouch and the adjacent pocket; and
the adjacent pocket being positioned in between the rear face of the multi-pocket pouch and the arbitrary pocket.

18. The hands-on wheel, transparent multi-pocket pouch for displaying personal identification documents as claimed in claim 16 comprises:
a first plurality of cover fasteners;
a second plurality of cover fasteners
a design panel;
the first plurality of cover fasteners being adjacently connected to the front face of the multi-pocket pouch;
the first plurality of cover fasteners being perimetrically distributed around the front face of the multi-pocket pouch;
the second plurality of cover fasteners being adjacently connected to a first face of the opaque cover;
the second plurality of cover fasteners being perimetrically distributed around the first face of the opaque cover;
each of the first plurality of cover fasteners being attached to a corresponding fastener from the second plurality of cover fasteners; and
the design panel being superimposed onto a second face of the opaque cover, opposite to the front face of the multi-pocket pouch.

19. The hands-on wheel, transparent multi-pocket pouch for displaying personal identification documents as claimed in claim 16, wherein the multi-pocket pouch is made from a transparent material.

20. The hands-on wheel, transparent multi-pocket pouch for displaying personal identification documents as claimed in claim 1 comprises:
the external device fastener being a plurality of detachable fasteners;
the plurality of detachable fasteners being adjacently connected to the rear face of the multi-pocket pouch; and
the plurality of detachable fasteners being perimetrically distributed around the rear face of the multi-pocket pouch.
